(19) United States
(12) Patent Application Publication
(10) Pub. No.: US 2026/0175628 A1
(43) Pub. Date: Jun. 25, 2026

(54) SYSTEM AND METHOD FOR WHEEL TYPE BASED VEHICLE CONTROL, SPACE SAVER WHEEL, VEHICLE AND COMPUTER PROGRAM

(71) Applicant: JAGUAR LAND ROVER LIMITED, Warwickshire (GB)

(72) Inventor: Ian TILFORD, Whitley, Coventry, Warwickshire (GB)

(21) Appl. No.: 19/127,497

(22) PCT Filed: Oct. 25, 2023
(86) PCT No.: PCT/EP2023/079831

§ 371 Date: May 6, 2025

(30) Foreign Application Priority Data
Nov. 7, 2022 (GB) 2216536.9

(51) Int. Cl. B60C 23/04

(52) U.S. Cl. CPC B60C 23/045; B60C 23/0408; B60C 23/0416; B60C 23/0433; B60C 23/0488; B60W 2520/10; B60W 2552/05; B60W 2554/00

(57) ABSTRACT

The invention relates to a control system (100) for an advanced driver assistance system, ADAS (300), of a vehicle. The control system comprises one or more controllers (110). The control system is configured to: receive a space-saver wheel signal (206), wherein the space-saver wheel signal is indicative of the space-saver wheel (202) being operatively fitted to the vehicle; determine, in dependence on the space-saver wheel signal, an operating parameter range of the vehicle; and output an operating parameter range signal (208) to the ADAS to cause the ADAS to control the operation of the vehicle to be within the operating parameter range. The invention further relates to a space-saver wheel, a system, a vehicle, a method, a computer software and a computer-readable storage medium.

### TECHNICAL FIELD

The present disclosure relates to control systems for vehicles, such as a control system for an advanced driver assistance system (ADAS) of a vehicle. Example control systems account for a wheel type in use on the vehicle. Aspects relate to control systems for an ADAS of a vehicle, space-saver wheels, systems, vehicles, methods, computer software and computer-readable storage media, as claimed in the appended claims.

### BACKGROUND

Wheeled vehicles, such as cars, may contain a spare wheel so that, in the event of a tyre failure, the failed wheel may be replaced with the spare wheel so the driver can drive the vehicle using the spare wheel, for example to allow the vehicle to be driven to a garage to have a replacement tyre fitted.

Some vehicles are fitted with a so-called space-saver wheel or “skinny spare” which can be stored in a boot space or similar of the vehicle without occupying as much room as a full sized wheel. However, because a space-saver wheel is designed for occasional or emergency use, and is smaller than a regular wheel, often it cannot be used in the same way as a regular wheel. For example, driving using a space-saver wheel may be advised below a speed limit which is lower than the speed limit found on some roads.

Furthermore, a regular wheel can be fitted with a device which is capable of communicating data about the wheel to a controller on board the vehicle. For example, an identifier, or a pressure reading, for that wheel may be communicated from a wheel-based transmitter to a vehicle computer. However, space-saver wheels do not have the capability for communicating any data, and as such, no data about the space-saver wheel can be reported.

It may be advantageous to be able to obtain data regarding all the wheels fitted to a vehicle, even if one is an occasional use wheel, such as a space-saver wheel. It is an aim of the present disclosure to address one or more of the disadvantages associated with the prior art.

### SUMMARY OF THE INVENTION

In an aspect there is provided a control system for an advanced driver assistance system, ADAS, of a vehicle, the control system comprising one or more controllers, the control system configured to: receive a space-saver wheel signal, wherein the space-saver wheel signal is indicative of the space-saver wheel being operatively fitted to the vehicle; determine, in dependence on the space-saver wheel signal, an operating parameter range of the vehicle; and output an operating parameter range signal to the ADAS to cause the ADAS to control the operation of the vehicle to be within the operating parameter range.

Advantageously, the vehicle can be automatically controlled according to the specifications of the space-saver wheel, which may for example involve reducing the maximum vehicle speed. By actively receiving the space-saver wheel signal from the transmitter of the space-saver wheel, the vehicle control may be adapted to use according to the capabilities of the space-saver tyre shortly after transmission of the signal from the space-saver wheel transmitter, as opposed to waiting for a time-out signal due to no transmission being received from the space-saver wheel.

The space-saver wheel signal may be indicative of the operating parameter range of the vehicle. Advantageously, the space-saver wheel may provide an indication of what the operating parameter range of the vehicle needs to be according to the specifications of the space-saver wheel. This may include, for example, reducing the maximum vehicle speed to be within the recommended operating speed of the space-saver wheel. The indication may be, for example, a letter code indicating a maximum speed which the control system can use to retrieve the operating parameter range corresponding to the letter code from a look up table or similar.

The operating parameter range may indicate a recommended:
operating speed range of the vehicle when fitted with the space-saver wheel; linear acceleration range of the vehicle when fitted with the space-saver wheel;
lateral acceleration range of the vehicle when fitted with the space-saver wheel;
linear velocity range of the vehicle when fitted with the space-saver wheel; or
lateral velocity range of the vehicle when fitted with the space-saver wheel.

The control system may be further configured to receive a rotation signal from a transmitter of the space-saver wheel. The rotation signal may be indicative that the space-saver wheel is operatively fitted to the vehicle in motion. Advantageously, the space-saver wheel signal may be sent to the control system if the vehicle is in use, rather than being sent when the vehicle is stationary, to help save power. The rotation signal may thus allow the control system to be instructed that the space-saver wheel is fitted and in use for moving the vehicle.

The space-saver wheel signal may be indicative of a predetermined speed limit within which the vehicle is to operate according to an operating capability of the space-saver wheel. In this way, the ADAS may be controlled to not exceed the maximum speed for the space-saver wheel triggered by receipt of the signal.

The control system may be further configured to, in response to determining that the current vehicle speed exceeds the predetermined speed limit according to an operating capability of the space-saver wheel, disable an automated driving function of the ADAS.

The control system may be further configured to cause the ADAS to control the speed of the vehicle to be within the predetermined speed limit.

Thus, advantageously, the vehicle may be automatically controlled by the ADAS in accordance with the specifications of the space-saver wheel.

The control system may be further configured to: receive a space-saver wheel tyre pressure signal, indicative of a tyre pressure of the space-saver wheel, from the transmitter of the space-saver wheel; determine whether the tyre pressure of the space-saver wheel is within a predetermined space-saver wheel tyre pressure operating range; and output an indication of whether the tyre pressure of the space-saver wheel is within or outside the space-saver wheel tyre pressure operating range. Thus the space-saver wheel signal may indicate if the pressure of the space-saver wheel tyre is outside the preferred operating range, which is advantageous since typically, the space-saver wheel tyre pressure is not regularly checked due to the space-saver wheel being stowed away, and so the tyre pressure may be more likely to be outside the preferred operating range. The control system may be further configured to, in dependence on the determination that the tyre pressure of the space-saver wheel is outside a predetermined space-saver wheel tyre pressure operating range, disable an automated driving function of the ADAS. Thus, advantageously, the vehicle may be prevented from being automatically controlled by the ADAS in accordance with the pressure of the space-saver wheel being outside the preferred operating range.

The control system may be configured to receive tyre pressure monitoring system, TPMS, signals from the vehicle wheels, and the space-saver wheel signal may be received from a TPMS valve fitted in the space-saver wheel.

In an aspect there is provided a space-saver wheel comprising a transmitter, the transmitter configured to transmit a space-saver wheel signal for receipt by a control system of the vehicle, wherein the space-saver wheel signal is indicative of the vehicle being operatively fitted with a space-saver wheel.

In this way, a vehicle fitted with the space-saver wheel is therefore able to operate within an operating parameter range dependent on the operating capability of the space-saver wheel. The space-saver wheel signal may be indicative of the operating parameter range of the vehicle. The transmitted of the space-saver wheel of claim 10, wherein the transmitter is comprised in a tyre pressure monitoring system, TPMS, valve fitted in the space-saver wheel.

In an aspect there is provided a system, comprising: a control system as described herein; and one or more of the ADAS; and the space-saver wheel comprising the transmitter.

In an aspect there is provided a vehicle comprising any control system disclosed herein, or any space-saver wheel disclosed herein, or any system disclosed herein.

In an aspect there is provided a method, comprising:
receiving a space-saver wheel signal from a transmitter of a space-saver wheel, wherein the space-saver wheel signal is indicative of the space-saver wheel being operatively fitted to the vehicle;
determining, in dependence on the space-saver wheel signal, an operating parameter range of the vehicle; and
outputting an operating parameter range signal to an ADAS of the vehicle to cause the ADAS to control the operation of the vehicle to be within the operating parameter range.

In an aspect there is provided computer software which, when executed on a processor of any control system disclosed herein is arranged to perform any method disclosed herein.

In an aspect there is provided a non-transitory, computer-readable storage medium storing instructions thereon that, when executed by one or more electronic processors of any control system disclosed herein, causes the one or more electronic processors to carry out any method disclosed herein.

In an aspect there is provided a control system for an advanced driver assistance system, ADAS, of a vehicle, the control system comprising one or more controllers, the control system configured to: receive a wheel type signal, wherein the wheel type signal is indicative of a wheel type operatively fitted to the vehicle, wherein the wheel type is associated with one or more predetermined vehicle operating parameter ranges; determine, in dependence on the wheel type signal, the one or more predetermined vehicle operating parameter ranges; and output an operating parameter range signal to the ADAS to cause the ADAS to control the operation of the vehicle to be within the one or more predetermined vehicle operating parameter ranges.

In an aspect there is provided a control system for an advanced driver assistance system, ADAS, of a vehicle, the control system comprising one or more controllers, the control system configured to: receive a replacement wheel signal, wherein the replacement wheel signal is indicative of a wheel of a second wheel type operatively fitted to the vehicle, wherein the second wheel type is different from a first wheel type of a previously fitted wheel; determine, in dependence on the replacement wheel signal, an operating parameter range of the vehicle; and output an operating parameter range signal to the ADAS to cause the ADAS to control the operation of the vehicle to be within the operating parameter range.

In some examples, the second wheel type may be a non-standard wheel type compared to a wheel of a first wheel type. The first wheel type may be a regular or every day wheel type, for example a summer tyre wheel or an all-season tyre wheel. The second wheel type may, for example, be a winter tyre wheel type, a space-saver wheel type, a run-flat wheel type or a high performance tyre type.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more examples will now be described, by way of example only, with reference to the accompanying drawings, in which:

FIG. 1 shows a control system according to examples disclosed herein;

FIG. 2 shows a system comprising a control system, a space-saver wheel, and an ADAS, according to examples disclosed herein;

FIG. 3 shows an example transmission signal from a space-saver wheel transmitter according to examples disclosed herein;

FIG. 4 shows an example of ADAS control according to examples disclosed herein;

FIG. 5 shows an example of pressure reporting from the space-saver wheel according to examples disclosed herein;

FIG. 6 shows an example of control system operation accounting for space-saver wheel motion and space-saver wheel tyre pressure monitoring according to examples disclosed herein;

FIG. 7 illustrates an example vehicle according to examples disclosed herein; and

FIG. 8 shows an example method according to examples disclosed herein.

### DETAILED DESCRIPTION

Wheeled vehicles, such as cars, may be fitted with a spare wheel so that in the event of a tyre failure, such as a puncture or flat tyre, the failed wheel may be replaced with the spare wheel so the driver can drive the vehicle using the spare wheel. The spare wheel is often designed for emergency or occasional use only, for example to allow the vehicle to be driven, after having the spare wheel fitted, to a garage to have a replacement tyre fitted.

Some vehicles are fitted with a so-called space-saver wheel or “skinny spare” which can be stored in a boot space or similar of the vehicle without occupying as much room as a full sized wheel. However, because a space-saver wheel is designed for occasional or emergency use, and is different to (e.g. smaller than) a regular wheel, often it cannot be used in the same way as a regular wheel. For example, driving using a space-saver wheel may be advised below a speed limit which is lower than the speed limit found on some roads. As an example, driving using a space-saver wheel may be advised up to but not exceeding 50 miles per hour (mph) or 80 kilometres per hour (kph), even though some roads may have a legal speed limit which is higher than this. A space-saver wheel may be considered to be a wheel which is suitable for temporary driving, such as from the location of fitting the space-saving wheel to the vehicle to a tyre repair shop or garage, so the space-saver wheel can be replaced by a regular wheel at the earliest opportunity. A “regular wheel” (which may also be called a “standard wheel”), as opposed to a space-saver wheel, may be considered to be a non-temporary wheel which is suitable for everyday use, or for regular driving without requiring replacement unless a fault arises, such as a puncture, flat tyre, or having low tyre tread through prolonged wear.

A regular wheel can be fitted with a device, which may be in the tyre valve, which is capable of communicating data about the wheel to a controller on board the vehicle. For example, a regular tyre may be fitted with a tyre-pressure monitoring system, TPMS, wheel unit. Such a TPMS wheel unit may be located in a valve of the wheel, or elsewhere within the wheel and tyre. TPMS wheel units may each have a different identifier, similar to a MAC address, which can be used to determine which corner of the car the wheel to which the TPMS wheel unit is located. This can allow for data for that wheel to be reported, such as the tyre pressure for that wheel, to provide for low pressure warning detection.

However, space-saver wheels are often fitted with a rubber valve or other simple mechanical stopper to prevent air escaping from the tyre. Space-saver wheels in the art do not have the capability for communicating any data, and as such, no data about the space-saver wheel can be reported to the on-board computer in the same way as for a regular wheel fitted with TPMS or similar.

Examples disclosed herein aim to address the shortcomings in the art by fitting a radio transmitter to a space-saver wheel which can transmit a signal which is configured to, at least, indicate that a space-saver wheel is fitted to the vehicle. From this signal, the vehicle control system is able to determine that a space-saver wheel is fitted and may adapt operation of the vehicle accordingly. For example, use of a space-saver wheel may be associated with an operating parameter range for the vehicle associated with use of the space-saver wheel. A control signal may be provided to control the vehicle according to the operating parameter range. For example, a signal may be transmitted to the ADAS of the vehicle to cause the ADAS to control the operation of the vehicle to be within the operating parameter range (e.g. reduce the maximum speed at which the vehicle can travel while the space-saver wheel is fitted according to the operating specification for the space-saver wheel).

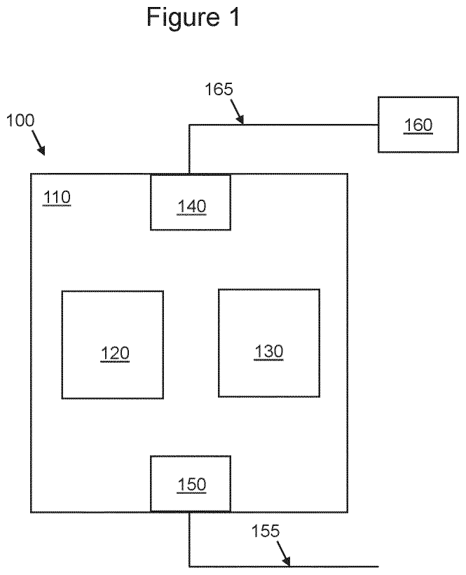

FIG. 1 shows a control system 100 for an advanced driver assistance system, ADAS, of a vehicle. The vehicle may be a wheeled vehicle, such as an automobile, or may be another type of vehicle. The control system 100 comprises one controller 110, although in other examples there may be plural controllers 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 165 of the controller 110. The output means 150 may comprise an electrical output 155 of the controller 110. The input 140 is arranged to receive one or more input signals via the electrical input 165, for example from an external computing device 160.

The control system 100 is configured to receive a space-saver wheel signal. The space-saver wheel signal is indicative of the space-saver wheel being operatively fitted to the vehicle. That is, the space-saver wheel is fitted to the vehicle wheel axle for the vehicle to use for driving, as opposed to being located in a boot space or otherwise stored away.

The control system 100 is configured to determine, in dependence on the space-saver wheel signal, an operating parameter range of the vehicle. For example, the control system 100 may receive a space-saver wheel signal which indicates that a space-saver wheel is fitted, and the control system may then determine how to adjust operation of the vehicle in dependence, for example by looking up a speed limit or other driving parameter which is within the suggested operating range for the space-saver wheel. As another example, the control system 100 may receive a space-saver wheel signal which indicates one or more operating parameter ranges for the space-saver wheel and the control system may then determine how to adjust operation of the vehicle in dependence on the received operating parameter range(s).

The control system 100 is configured to output an operating parameter range signal to the ADAS to cause the ADAS to control the operation of the vehicle to be within the operating parameter range. For example, the maximum speed, the maximum linear acceleration, the maximum lateral acceleration, and/or other operating parameter of the vehicle may be adapted to account for the use of a space-saver wheel.

Advantageously, the vehicle can be automatically controlled according to the specifications of the space-saver wheel. By actively receiving the space-saver wheel signal from the transmitter of the space-saver wheel, the vehicle control may be adapted to use according to the capabilities of the space-saver tyre shortly after transmission of the signal from the space-saver wheel transmitter, as opposed to waiting for a time-out signal due to no transmission being received from the space-saver wheel. In some examples, a space-saver wheel signal may be transmitted from a TPMS fitted to the space-saver wheel. The control system may be configured to operate with a TPMS-wheel mounted transmitter, and may receive the space-saver wheel signal within a short time (e.g. 16 seconds) of the vehicle moving above a predetermined trigger speed (e.g. 15 mph/24 kph). After receipt of the space-saver wheel signal, the control system may then localise the space-saver wheel on the vehicle (e.g. left side or right side, front axle or rear axle) and transmit a signal to the ADAS to control the ADAS according to the operating parameters for the space-saver wheel, such as not exceeding 50 mph/80 kph, performing anti-lock braking system (ABS) braking appropriately for a vehicle fitted with a space-saver wheel, performing ADAS controlled stability control appropriately for a vehicle fitted with a space-saver wheel, or other automatically controlled driving behaviour.

In the absence of any deliberate signalling from the space-saver wheel to the control system to indicate that the space-saver wheel is fitted for use on the vehicle, for example in the case of a space-saver wheel being fitted with a basic rubber valve and no signal transmission apparatus, it can take much longer for the control systems on board the vehicle to determine that the vehicle is fitted with a space-saver wheel (or at least, fitted with a wheel incapable of transmitting any signal to indicate a property of the wheel). For example, if the event indicating to the control system that a fitted wheel may be a space-saver wheel is the lack of detection of any wheel identification signal, then a period of time (for example, 10 minutes or more) may elapse during vehicle motion until a determination is made that a wheel is not transmitting any signalling and thus may be a space-saver wheel which does not have any transmission capability.

The transmitter of the space-saver wheel in some examples may provide an identifier to the control system to indicate that a space-saver wheel is fitted. The identifier may be unique to the particular space-saver to which it is fitted, in some examples. The identifier may be a generic “space-saver” identifier indicating that any space-saver wheel is fitted, in some examples. The transmitter of the space-saver wheel in some examples may be a TPMS transmitter which can operate as part of a TPMS configured to determine tyre pressure. A TPMS can send a signal to a control system on board a vehicle and may provide an indication to a driver, such as an illuminated light on a dashboard display, if a tyre is not at the recommended tyre pressure (e.g. overinflated or underinflated, perhaps due to a puncture).

TPMS may operate as indirect TPMS or direct TPMS. An indirect TPMS may use wheel speed sensors also used by an anti-lock brake system, to measure the rate of revolution of the wheel. The revolution rates of each wheel may be compared and used to make a determination about the fitted wheels. Using the revolution rates, the tyre size may be determined in some examples. In some examples, the revolution rate of each wheel compared with the other wheels may be used to determine if the tyre of that wheel is wheel is inflated differently to the tyres of the other wheels. For example, if a wheel is spinning faster than expected, this may indicate underinflation. Thus indirect TPMS determine tyre pressure indirectly through sensing wheel rotation. Direct TPMS uses pressure monitoring sensors within each tyre that monitor specific pressure levels. In some examples, direct TPMS sensors may sense tyre temperature, or other information. The sensed data may be transmitted to a control system on board for interpretation. Each direct TPMS sensor may have a unique serial number so a distinction can be made for each particular wheel.

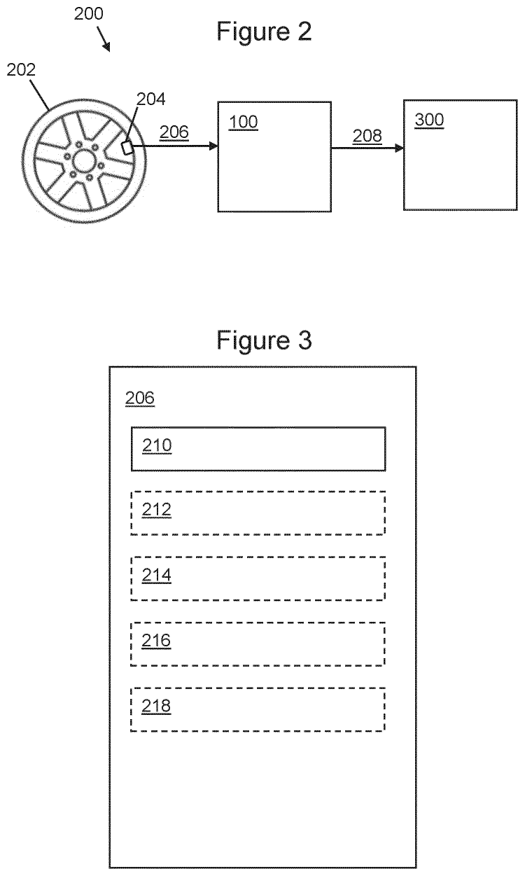

FIG. 2 shows a system 200 comprising a control system 100, a space-saver wheel 202 comprising a transmitter 204, and an ADAS 300. The transmitter 204 is configured to transmit a space-saver wheel signal for receipt by a control system 100 of a vehicle (i.e. the vehicle to which the space-saver wheel is fitted for use). The space-saver wheel signal is indicative of the vehicle being operatively fitted with a space-saver wheel. Through transmission of the space-saver wheel 202 to the control system 100 of the vehicle, the vehicle is able to operate within an operating parameter range dependent on the operating capability of the space-saver wheel. The space-saver wheel signal may be indicative of an operating parameter range of the vehicle, for example a range of lateral acceleration, longitudinal acceleration, lateral velocity, longitudinal velocity, speed, or other vehicle parameter. The transmitter may be comprised in a tyre pressure monitoring system, TPMS, valve fitted in the space-saver wheel 202 in some examples.

As discussed above, the control system 100 is configured to: receive a space-saver wheel signal 206, wherein the space-saver wheel signal 206 is indicative of the space-saver wheel 202 being operatively fitted to the vehicle; determine, in dependence on the space-saver wheel signal 206, an operating parameter range of the vehicle; and output an operating parameter range signal 208 to the ADAS 300 to cause the ADAS 300 to control the operation of the vehicle to be within the operating parameter range. In other examples, more broadly, an ADAS control signal 208 may be provided to the ADAS in dependence on a determination by the control system that the ADAS should be controlled according to the fitted wheel 202. The space-saver wheel signal 206 may be transmitted from a transmitter 204, such as a TPMS transmitter, of the space-saver wheel 202.

The space-saver wheel signal 206 may at least indicate that a space-saver wheel is fitted to the vehicle. The space-saver wheel signal 206 may be indicative of the operating parameter range of the vehicle. Advantageously, the space-saver wheel 202 may provide an indication of what the operating parameter range of the vehicle needs to be according to the specifications of the space-saver wheel 202. The control system can use the code transmitted as a signal 206 from the transmitter 204 to retrieve the operating parameter range corresponding to the letter code from a look up table or similar.

The control system 100 may be further configured to receive a rotation signal from a transmitter 204 of the space-saver wheel 202. The rotation signal may be indicative that the space-saver wheel 202 is operatively fitted to the vehicle in motion.

Advantageously, the space-saver wheel signal 206 may be sent to the control system 100 if the vehicle is in use, rather than being sent when the vehicle is stationary, to help save power. The rotation signal may thus allow the control system 100 to be instructed that the space-saver wheel 202 is fitted and in use for moving the vehicle. The operation of sensor systems to detect wheel rotation are known to the person skilled in the art.

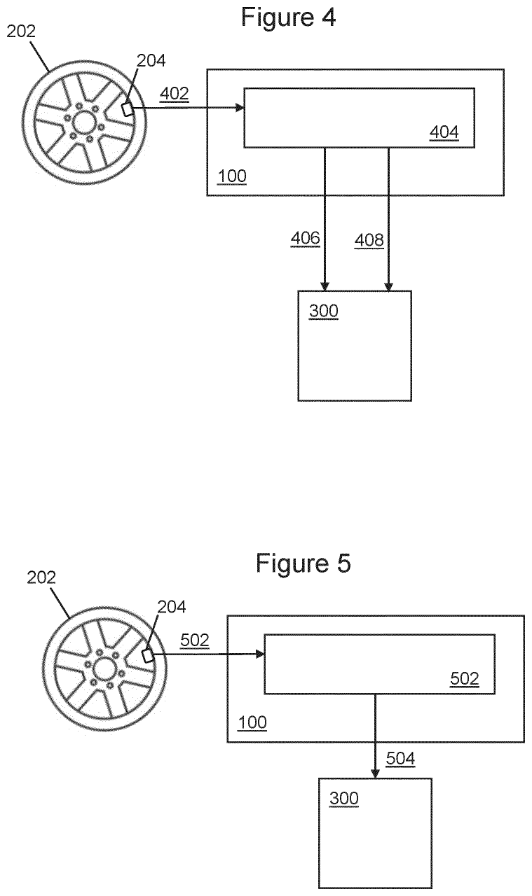

FIG. 3 shows a schematic example of the contents of a transmitted space-saver wheel signal 206 which may be sent from a space-saver wheel transmitter 204. For example, the space-saver wheel signal 206 includes an indication 210 that a space-saver wheel 202 is fitted to the vehicle. The space-saver wheel signal 206 may include one or more further indications 212, 214, 216, 218 indicative of some parameter of the space-saver wheel 202. For example, the space-saver wheel signal 206 may comprise an indication of a predetermined speed limit within which the vehicle is to operate 212 as discussed in relation to FIG. 4. For example, the space-saver wheel signal 206 may comprise an indication of a tyre pressure 214 of the space-saver wheel 202 as discussed in relation to FIG. 5. For example, the space-saver wheel signal 206 may comprise an indication of a rotation speed 216 of the space-saver wheel 202. For example, the space-saver wheel signal 206 may comprise an indication of an acceleration of rotation 218 of the space-saver wheel 202. Other indications are possible.

FIG. 4 shows an example of ADAS 300 control by a control system 100 as disclosed herein. In this example, the transmitter 204 of the space-saver wheel 202 is in communication with the control system 100 (the communication may be one way from the transmitter 204 to the control system 100). The space-saver wheel signal 402 may be indicative of a predetermined speed limit within which the vehicle is to operate according to an operating capability of the space-saver wheel 202. In this way, the ADAS may be controlled to not exceed the maximum speed for the space-saver wheel triggered by receipt of the signal.

The control system 100 may be configured to determine 404 that the current vehicle speed exceeds the predetermined speed limit according to an operating capability of the space-saver wheel. The control system 100 may be configured to, in response to determining that the current vehicle speed exceeds the predetermined speed limit, disable an automated driving function of the ADAS 300, for example, by transmitting an ADAS disable function control signal 406 to the ADAS 200. The control system 100 may be configured to cause the ADAS to control the speed of the vehicle to be within the predetermined speed limit, for example, by transmitting an ADAS vehicle speed control signal 408 to the ADAS 200. Of course in other examples, the control system 100 may make a different determination (such as limiting vehicle speed at an upcoming corner, or limiting acceleration) and send a corresponding control signal to the ADAS to control the ADAS operation.

In the absence of any deliberate signalling from the space-saver wheel 202 to the control system 100 to indicate that the space-saver wheel 202 is fitted for use on the vehicle, it can take much longer for the control systems 100 on board the vehicle to determine that the vehicle is fitted with a space-saver wheel (or at least, fitted with a wheel incapable of transmitting any signal to indicate a property of the wheel). For example, if the event indicating to the control system 100 that a fitted wheel may be a space-saver wheel is the lack of detection of any wheel identification signal, then a period of time may elapse (e.g. 10 minutes) during vehicle motion until a determination is made that a wheel is not transmitting any signalling, and thus may be a space-saver wheel which does not have any transmission capability. This would mean that the ADAS may operate as if all regular wheels are fitted, without adapting for any restrictions or capabilities of the space-saver wheel, for a period of time during which a vehicle may reach a high speed exceeding the rating for the space-saver wheel, or being handled in manoeuvres such as cornering in a way which the ADAS is operating according to use with all regular wheels and not accommodating the capabilities of the space-saver wheel. Therefore examples disclosed here allow for much faster recognition by the control system, and thus the ADAS, that a space-saver wheel is fitted and the ADAS may then by controlled accordingly.

FIG. 5 shows an example of pressure reporting from the space-saver wheel 202. In this example, the transmitter 204 of the space-saver wheel 202 is in communication with the control system 100 (which may be one way communication from the transmitter 204 to the receiving control system 100). The space-saver wheel signal 502 may be indicative of a tyre pressure of the space-saver wheel. In some examples, the control system may be configured to receive tyre pressure monitoring system, TPMS, signals from the vehicle wheels, and the space-saver wheel signal may be received from a TPMS valve fitted in the space-saver wheel. The control system 100 is configured to receive the space-saver wheel tyre pressure signal 502, indicative of a tyre pressure of the space-saver wheel 202, from the transmitter 204 of the space-saver wheel. The control system 100 may be configured to determine whether the tyre pressure of the space-saver wheel 202 is within a predetermined space-saver wheel tyre pressure operating range. The control system 100 may output an indication 504 of whether the tyre pressure of the space-saver wheel 202 is within or outside the space-saver wheel tyre pressure operating range. Thus the space-saver wheel signal 502 may indicate if the pressure of the space-saver wheel 202 tyre is outside the preferred operating range. This is advantageous since typically, the space-saver wheel 202 tyre pressure may not be regularly checked due to the space-saver wheel 202 usually being stowed away, and so the tyre pressure may be more likely to be outside the preferred operating range.

The control system 100 may be further configured to, in dependence on the determination that the tyre pressure of the space-saver wheel 202 is outside a predetermined space-saver wheel tyre pressure operating range, disable an automated driving function of the ADAS (for example by transmitting a tyre pressure control signal 504 to the ADAS 300). The pressure control signal 504 may cause the ADAS 300 to stop, or limit, control of the vehicle in dependence on the tyre pressure of the space-saver wheel 202. Thus, advantageously, the vehicle may be prevented from being automatically controlled by the ADAS 300 (that is, ADAS 300 control may be limited) in accordance with the pressure of the space-saver wheel 202 being outside the preferred operating range.

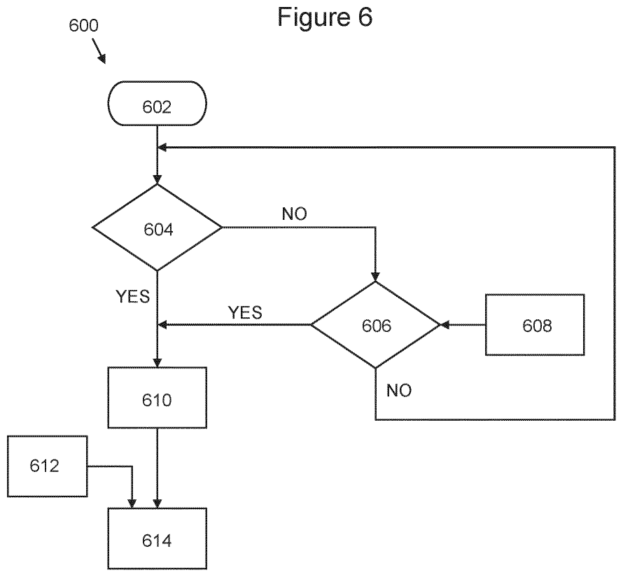

FIG. 6 shows an example of control system operation 600 accounting for space-saver wheel motion and space-saver wheel tyre pressure monitoring. The process starts 602 and a determination is made in step 604 whether the space-saver wheel is moving consistent with wheel rotation due to the wheel being operatively fitted to a vehicle for use i.e. fitted to a vehicle axle. This may be performed by a motion sensor attached to the space-saver wheel, for example as part of a TPMS. If no motion is sensed, the system determines in step 606 whether there is a pressure change for that wheel tyre compared with the last measured pressure for that wheel tyre. The pressure may be determined periodically, for example using a pressure sensor 608 (such as direct or indirect TPMS). The pressure may by measured, for example every 1 second in some examples.

If there is no change in pressure (within a predetermined tolerance) then the process returns back to step 604 and re-determines if the wheel is rotating. If there is a change in pressure, and/or if from the earlier step 604 it is determined that the wheel is rotating, the process measures in step 610 one or more parameters of the space-saver wheel. The measurement may be of one or more of: the tyre pressure, the tyre temperature, a condition of a battery of the pressure and/or temperature sensor (e.g. the TPMS sensor or other sensor(s)), the velocity of the wheel, the acceleration of the wheel, or other wheel parameter.

The measured parameter(s) are then reported e.g. via wireless transmission, as a radio signal, from the wheel sensor(s) to the control system in step 614. Also reported to the control system, in step 612, is an identifier that the wheel is a space-saver wheel so the control system can correspond the sensor reading(s) with the relevant wheel. Thus, the control system can decode the received signal(s) and determine if the parameter(s) are each within an approved range for that space-saver wheel (the approved range for the parameters may be different for a space-saver wheel compared with a regular wheel).

In this way, the properties of the space-saver wheel can be monitored and a driver alerted if there is a problem, for example, the space-saver wheel tyre is underinflated. Moreover, the fact that a space-saver wheel is fitted, and possibly one or more parameters of the space-saver wheel, may be fed into the ADAS of the vehicle so that control of the vehicle by the ADAS is performed according to the space-saver wheel being fitted—for example limiting the maximum speed. Deliberate reporting of the space-saver wheel being fitted allows for a quicker determination by the ADAS that operation may need to be adapted to accommodate the capabilities of the space-saver wheel, rather than relying on a lack of any reporting from the wheel (in the case of the space-saver wheel not having any transmission capability).

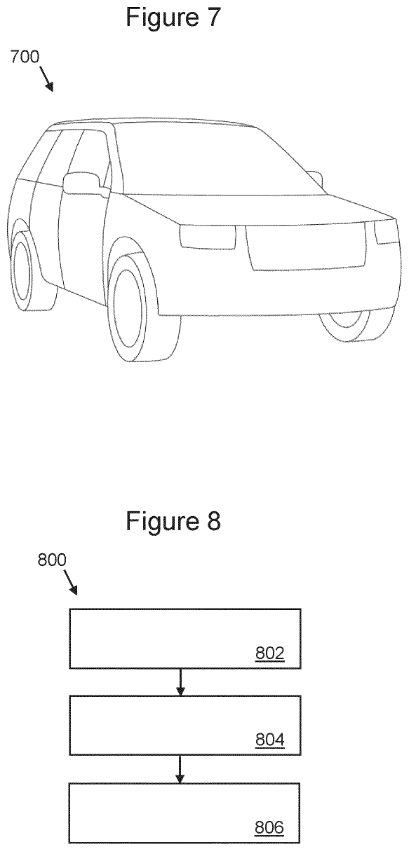

FIG. 7 illustrates an example vehicle 700, for example comprising one or more of a control system 100, system 200, or space-saver wheel 202 as disclosed herein. The vehicle 700 in the present embodiment is an automobile, such as a wheeled vehicle, but it will be understood that the control system 100 and system 200 may be used in other types of suitable vehicle 700.

FIG. 8 shows an example method 800. The method 800 comprises receiving a space-saver wheel signal from a transmitter of a space-saver wheel 802, wherein the space-saver wheel signal is indicative of the space-saver wheel being operatively fitted to the vehicle. The method 800 comprises determining, in dependence on the space-saver wheel signal, an operating parameter range of the vehicle 804. The method 800 comprises outputting an operating parameter range signal to an ADAS of the vehicle 806 to cause the ADAS to control the operation of the vehicle to be within the operating parameter range. Computer software, when executed on a processor of any control system disclosed herein, may be arranged to perform this method 800 or any method disclosed herein. A non-transitory, computer-readable storage medium storing instructions thereon, when executed by one or more electronic processors of any control system disclosed herein, may cause the one or more electronic processors to carry out this method 800 or any method disclosed herein.

While examples disclosed herein are set out in reference to a space-saver tyre, it will be understood that such examples may be adapted to apply to other types of wheel or tyre, for example, a run-flat tyre, a winter tyre, a high performance tyre, or other tyre type which may affect the operation of the ADAS for the vehicle to which the wheel is fitted.

As used here, ‘connected’ means either ‘mechanically connected’ or ‘electrically connected’ either directly or indirectly. Connection does not have to be galvanic. Where the control system is concerned, connected means operably coupled to the extent that messages are transmitted and received via the appropriate communication means. The term “control system” may be understood to cover a controller, control module, or control element and need not necessary be a multi-element or distributed system (although it may be in some examples).

It will be appreciated that various changes and modifications can be made to the present disclosed examples without departing from the scope of the present application as defined by the appended claims. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1. A control system for an advanced driver assistance system, ADAS, of a vehicle, the control system comprising one or more controllers, the control system configured to:
receive a space-saver wheel signal, wherein the space-saver wheel signal is indicative of a space-saver wheel being operatively fitted to the vehicle;
determine, in dependence on the space-saver wheel signal, an operating parameter range of the vehicle; and
output an operating parameter range signal to the ADAS to cause the ADAS to control the operation of the vehicle to be within the operating parameter range.

2. The control system of claim 1, wherein the space-saver wheel signal is indicative of the operating parameter range of the vehicle when fitted with the space-saver wheel.

3. The control system of claim 1, further configured to receive a rotation signal from a transmitter of the space-saver wheel, wherein the rotation signal is indicative that the space-saver wheel is operatively fitted to the vehicle in motion.

4. The control system of claim 1, wherein the space-saver wheel signal is indicative of a predetermined speed limit within which the vehicle is to operate according to an operating capability of the space-saver wheel.

5. The control system of claim 4, wherein the control system is further configured to:
in response to determining that the current vehicle speed exceeds the predetermined speed limit according to an operating capability of the space-saver wheel, disable an automated driving function of the ADAS.

6. The control system of claim 4, wherein the control system is further configured to:
cause the ADAS to control the speed of the vehicle to be within the predetermined speed limit.

7. The control system of claim 1, further configured to: receive a space-saver wheel tyre pressure signal, indicative of a tyre pressure of the space-saver wheel, from the transmitter of the space-saver wheel;
determine whether the tyre pressure of the space-saver wheel is within a predetermined space-saver wheel tyre pressure operating range; and
output an indication of whether the tyre pressure of the space-saver wheel is within or outside the space-saver wheel tyre pressure operating range.

8. The control system of claim 7, further configured to, in dependence on the determination that the tyre pressure of the space-saver wheel is outside a predetermined space-saver wheel tyre pressure operating range,
disable an automated driving function of the ADAS.

9. The control system of claim 1, wherein the control system is configured to receive tyre-pressure monitoring system, TPMS, signals from the vehicle wheels, and the space-saver wheel signal is received from a TPMS valve fitted in the space-saver wheel.

10. (canceled)

11. A system, comprising:
a control system according to claim 3; and one or more of the ADAS; and
the space-saver wheel comprising the transmitter.

12. (canceled)

13. A method, comprising:
receiving a space-saver wheel signal from a transmitter of a space-saver wheel, wherein the space-saver wheel signal is indicative of the space-saver wheel being operatively fitted to the vehicle;
determining, in dependence on the space-saver wheel signal, an operating parameter range of the vehicle; and
outputting an operating parameter range signal to an ADAS of the vehicle to cause the ADAS to control the operation of the vehicle to be within the operating parameter range.

14. (canceled)

15. A non-transitory, computer-readable storage medium storing instructions thereon that, when executed by one or more electronic processors of a control system according to claim 1, causes the one or more electronic processors to carry out a method according to claim 13.
